(19) United States
(12) Patent Application Publication
(10) Pub. No.: US 2010/0306018 A1
(43) Pub. Date: Dec. 2, 2010

(54) Meeting State Recall

(75) Inventors: Russ Burtner, Everett, WA (US); Kevin Russ, Bellevue, WA (US); Ian Sands, Seattle, WA (US); John Snavely, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/473,206

(22) Filed: May 27, 2009

(51) Int. Cl. G06Q 10/00; G06Q 90/00

(52) U.S. Cl. 705/9; 705/500; 705/7

(57) ABSTRACT

Meeting state recall may be provided. A meeting context may be saved at the end of and/or during an event. The meeting context may comprise, for example, a hardware configuration, a software configuration, a recording of the meeting, and/or data associated with a subject of the meeting. The meeting context may be associated with an ongoing project and may be restored at a subsequent meeting associated with the ongoing project.

### BACKGROUND

Meeting state recall is a process for recording and saving information regarding a previous meeting and restoring that information at a later time. In some situations, meeting rooms may be shared among multiple groups and/or projects. For example, a company may have a limited number of conference rooms and so different teams must schedule the conference room. In this conventional strategy, teams may need to set up the conference room, spend time reviewing previous meeting information, and deciding where to resume. At the end of the meeting, time must be spent capturing transient notes, such as those written on a whiteboard, updating task assignments, and resetting the conference room for the next team. This often causes problems because the conventional strategy wastes otherwise productive time at the beginning and end of the meetings. For example, a team may wind up having to re-write notes on a whiteboard or determining where in a presentation they left off at the beginning of a meeting and copying down notes from the whiteboard at the end.

### SUMMARY

Meeting state recall may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Meeting state recall may be provided. A meeting context may be saved at the end of and/or during an event. The meeting context may comprise, for example, a hardware configuration, a software configuration, a recording of the meeting, and/or data associated with a subject of the meeting. The meeting context may be associated with an ongoing project and may be restored at a subsequent meeting associated with the ongoing project.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a meeting environment;

FIG. 2 is a diagram illustrating a meeting state recall user interface;

FIG. 3 is a flow chart of a method for providing meeting state recall; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Meeting state recall may be provided. Consistent with embodiments of the present invention, notes, attendance records, task lists, presentations, and other contextual information prepared as part of a meeting may be saved. For example, documents may be scanned, recordings of the meeting may be transcribed, presentation progress may be stored, and/or electronic whiteboard notes may be captured. During later meetings, the saved information may be loaded and displayed in order to configure the meeting location to the saved state of the end of the last meeting. The information may be tied to a calendaring application, for example, allowing users to review and update information associated with previous meetings and/or schedule subsequent meetings. Hardware device states may be stored independently of the specific device, such as a particular whiteboard or projector, so that the meeting context may be restored in a different location, such as a separate conference room.

Tools may be provided for documenting and/or interacting with information about a meeting topic. For example, a user interface console may allow users to post an agenda, keep track of meeting attendees, document task requests, and/or take notes. Meeting environments, such as conference rooms, may be equipped with sensor technologies and large format display technologies allowing meeting events to be transcribed, pictures and/or video to be recorded, and/or device states to be captured. Thus, the meeting environment may comprise digital devices within the physical space, such as a multi-touch surface table, a projection system, and/or an electronic whiteboard. A meeting state recall system may record the contents of those devices and how they may be manipulated over the course of the meeting. After the meeting has ended, users may schedule another meeting regarding the same project and call upon the previous meeting context to repopulate the device states at the beginning of the new meeting.

The users may come in for their next meeting and the devices return to the state they were in at the end of the last meeting. For example, a presentation that was being projected on a projector in the room may return to the slide it was on at the end of the last meeting. Displayed notes may be brought back up, such as digital sticky notes from a brainstorm session, on a digital surface.

Furthermore, because each meeting associated with a project may be recorded, users may scroll through recorded states to go back to a previous state within the same and/or any of the previous meetings and the devices in the room may repopulate back to that previous state. For example, if someone wants to go to back to a point that someone else made earlier in a previous meeting, the meeting state from that time may be restored and branch off from there. Transcriptions may associate recorded comments with their speaker and documents may be associated with their author(s) and/or editor(s). These associations may be searched according to the associated user and/or other criteria in order to aid in locating points made by users during previous meetings.

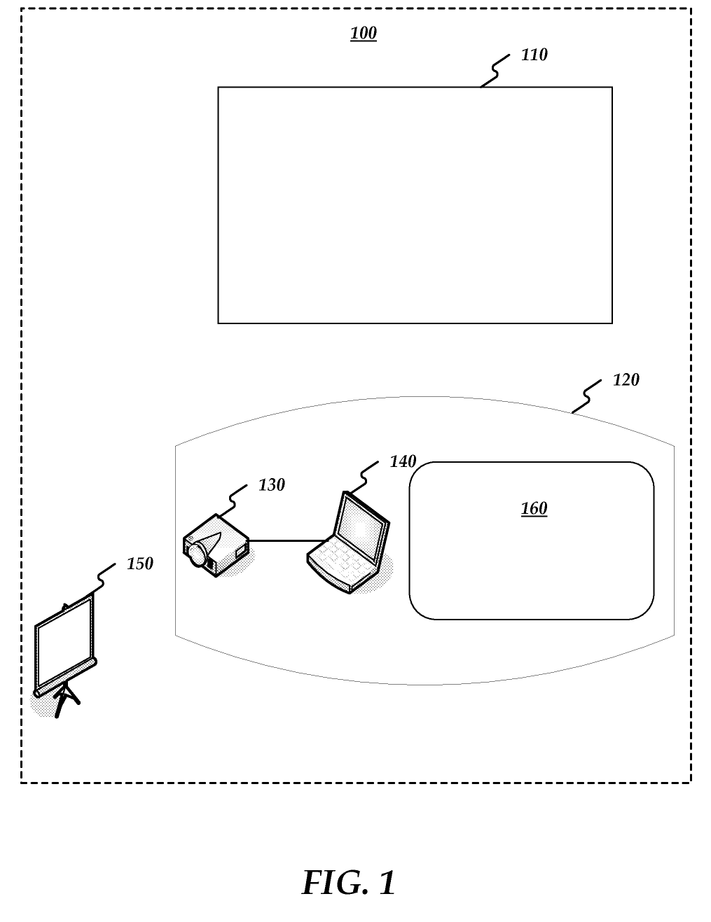

FIG. 1 is a block diagram of a meeting environment 100, such as a conference room. Environment 100 may comprise a whiteboard 110, a table 120, a projector 130, a computer 140, and a projector screen 150. Table 120 may comprise a multi-touch interface 160. Whiteboard 110 may comprise, for example, an interactive whiteboard operative to receive, display, save, and/or print user input electronically. Computer 140 may be operatively connected to projector 130, multi-touch interface 160, and/or whiteboard 110.

Multi-touch interface 160 may comprise a display screen allowing computer users to control graphical applications with one and/or more fingers. Multi-touch interface 160 may comprise software that recognizes multiple simultaneous touch points on an interface using, for example, heat, finger pressure, high capture rate cameras, infrared light, optic capture, tuned electromagnetic induction, ultrasonic receivers, transducer microphones, laser rangefinders, and/or shadow capture. An example of multi-touch interface 160 may comprise a Microsoft Surface™ product developed and sold by Microsoft® Corporation of Redmond, Wash.

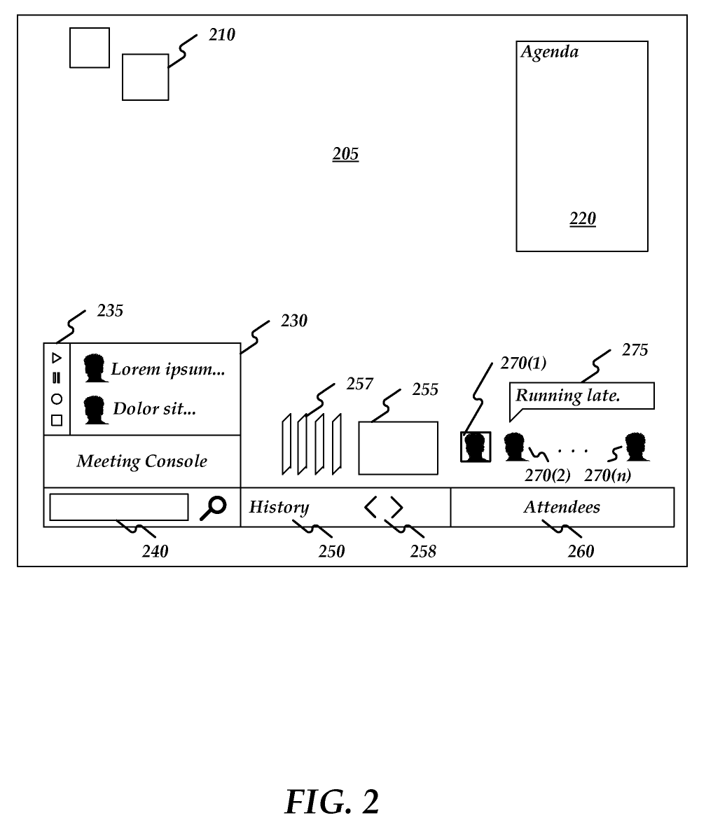

FIG. 2 is a diagram illustrating a user interface (UI) 200 for providing meeting state recall. UI 200 may be displayed on a display device such as a monitor, a tablet computer, a laptop, a programmable remote control, multi-touch interface 160, and/or whiteboard 110. UI 200 may comprise a main display area 205 that may display data such as a meeting note 210 and/or an agenda 220. Main display area 205 may display other data such as electronic documents, presentations, and/or projected information (not shown).

UI 200 may further comprise a transcription interface 230, a search interface 240, a context history interface 250 and an attendee interface 260. Transcription interface 230 may comprise, for example, a playback control interface 235 operative to control play, pause, record, and stop operations of a recording. Transcription interface 230 may further comprise a text display of a transcription. The text display may comprise information identifying participants recorded in the transcription. For example, a user icon or picture may be used to indicate where each participant began speaking. Consistent with embodiments of the invention, a separate text color and/or icon may be used for each speaker.

Search interface 240 may be operative to receive a user input and search information saved as part of the meeting context. For example, a user may enter a user's name as a search term. Transcription records may be searched for statements associated with that user's name and matching records may be displayed in transcription interface 230 and/or main display area 205.

Context history interface 250 may comprise a currently selected context 255 and at least one previous context 257. Currently selected context 255 and/or previous context 257 may comprise a preview image of main display area 205 as captured as part of the context. Context history interface 250 may be operative to receive a selection of a meeting context to load and may comprise a pair of scroll controls 258 to flip back and forth through saved contexts. As scroll controls 258 are selected, for example, previous context 257 may be displayed as the currently selected context.

Attendee interface 260 may comprise, for example, a plurality of user indicators 270(1) and 270(2) through 270(n). User indicator 270(i) may comprise a picture, a name, and/or an icon associated with the user. User indicator 270(i) may represent an attendee present at the meeting and/or a user associated with a topic of the meeting, such as a member of a project team. Consistent with embodiments of the invention, a currently speaking user, such as 270(1), may be identified and indicated with a border. Further consistent with embodiments of the invention, attendee interface 260 may be operative to receive and/or display a user status update 275, such as a notification that the user is running late, a display of the user's title, and/or the user's contact information.

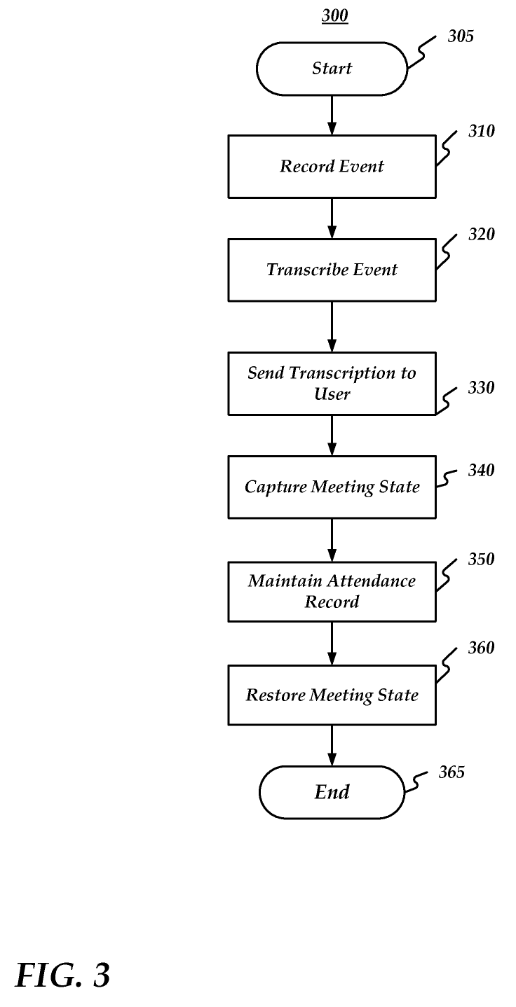

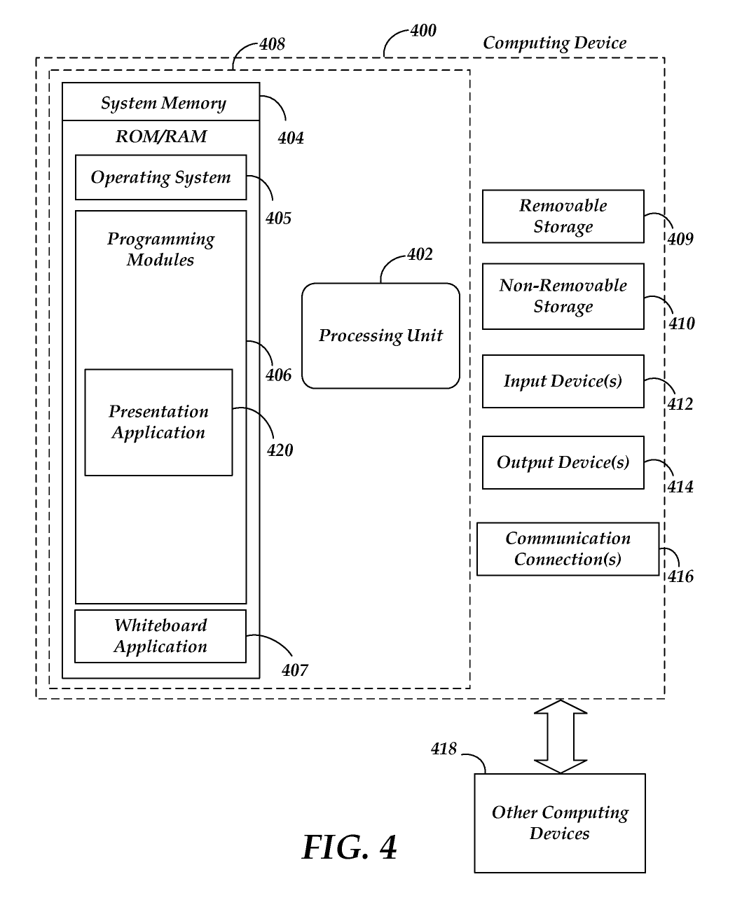

FIG. 3 is a flow chart setting forth the general stages involved in a method 300 consistent with an embodiment of the invention for providing meeting state recall. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may record an event.

From stage 310, where computing device 400 recorded the event, method 300 may advance to stage 320 where computing device 400 may transcribe the event recording. For example, the meeting environment may comprise an audio and/or video recording device. The recording may be processed by a speech recognition system operative to convert spoken input into machine readable and/or digital text, such as a Hidden Markov Model (HMM) based speech recognition system. The recording may also be processed by a voice and/or speaker recognition system operative to identify speakers according to the acoustic features of each speaker's voice. Each speaker's words may, for example, be associated with a team member of a project and indexed for efficient searching.

Once computing device 400 transcribed the recording in stage 320, method 300 may continue to stage 330 where computing device 400 may send the transcription to at least one user associated with the event. For example, computing device 400 may e-mail the meeting transcription to a team member who did not attend the meeting and/or a manager associated with the project. Consistent with embodiments of the invention, the transcription may be made available to a user via a network, such as on a shared network drive or a web server. Other state information about the event, such as hardware device states, notes, presentations, and/or other documents associated with the event may be stored with the transcription and/or sent to a user. For example, the meeting state information may be stored as part of a calendaring system and accessed through past and/or future scheduled meetings associated with the same project/topic.

After computing device 400 sends the transcription to the user in stage 330, method 300 may proceed to stage 340 where computing device 400 may capture a meeting state. The meeting state may comprise a hardware configuration, a software configuration, and/or an contextual information. For example, computer 140 may be using projector 130 to display an electronic presentation. Computer 140 may capture the state of projector 130, including hardware configuration information such as brightness, resolution, focus, etc. Computer 140 may associate the hardware configuration information with software configuration information such as active applications (e.g. an electronic presentation application and/or a digital whiteboard application) and/or contextual information such as which slide of the presentation is currently displayed. Another example may comprise receiving a digital note on an electronic display, such as whiteboard 110, and associating the note with a user, such as the note's author or a user assigned to a task related to the note. Similarly, a hardcopy document may be scanned into an electronic form and associated with a user associated with the subject of the meeting.

After computing device 400 captures the device state in stage 340, method 300 may proceed to stage 350 where computing device 400 may maintain an attendance record. For example, computer 140 may receive a user input comprising an attendance list and/or may access a calendar application comprising a list of accepting attendees. Consistent with embodiments of the invention, computing device 400 may use the transcription produced at stage 310 and/or a speaker recognition system to identify attendees present at the meeting. Further consistent with embodiments of the invention, computing device 400 may use a location sharing system operative to share users' locations with other users to determine who is present in the meeting location. An example location sharing system may comprise the system described in commonly owned co-pending patent application having Ser. No. 12/471,073, attorney docket number 14917.1221US01/MS326435.01, and entitled “Timed Location Sharing,” which is hereby incorporated by reference in its entirety.

After computing device 400 maintains the attendance record in stage 350, method 300 may proceed to stage 360 where computing device 400 may restore the captured device state. The stored meeting state information may be retrieved by computing device 400 operative to control another device such as whiteboard 110 and/or projector 130. For example, according to the state information, computer 140 may open a presentation file in an electronic presentation application, advance to a slide in the presentation comprising the last slide viewed during the previous meeting, and display the slide via projector 130. Other meeting context information may be restored and/or displayed, such as audio/video recordings of at least one previous meeting, a task list that may comprise a status of at least one task (e.g. not started, in progress, completed) and/or an assignment of the task to a team member, a timeline that may comprise information about progress over the course of previous meetings, such as a Gantt chart and/or previews of main display area 205 as saved at various times during the project, and/or document revisions. Revisions to notes and/or documents may be saved as part of the timeline and may be restored in response to a user command, such as through context history interface 250.

Consistent with embodiments of the invention, projector 130 may comprise a different device than the projector used at the previous meeting. For example, the previous meeting may have been held in a similarly equipped conference room using a different projection system, but computer 140 may open the presentation and display it on projector 130 available in the location being used for the current meeting. Other device states may be similarly restored despite being physically different devices from the devices on which the state was captured. In addition to restoring device states as they existed at the previous meeting, computing device 400 may prepare the meeting environment for the current meeting, such as displaying agenda 220, a task list, and/or a transcription of the previous meeting, such as in transcription display area 230. Once computing device 400 restores the device state in stage 340, method 300 may then end at stage 365.

Consistent with embodiments of the invention, computing device 400 may be further operative to schedule a subsequent meeting and/or analyze meeting efficiency. For example, previous meeting states may be reviewed in response to scheduling a next meeting. Open task items and/or topics discussed at the previous meeting may be prepared into proposed agenda items for the next meeting. Meeting state information may also be analyzed for patterns, such as often beginning with discussions on the same topic. Another example may comprise scanning the transcript for keywords, such as “next time,” “next week,” and/or “later” indicating topics intended to be discussed at subsequent meetings and providing reminders regarding these topics. Documents, notes, presentation, transcripts, and/or other information associated with the project and/or the users associated with the project may be searched according to scheduled discussion topics and displayed during the subsequent meeting. For example, a design document regarding a particular feature under development in a software project last reviewed several meetings prior may be recalled and displayed when the feature is on a subsequent meeting's agenda for further discussion.

Further consistent with embodiments of the invention, computing device 400 may analyze a list of unfinished tasks associated with the project and assign a user associated with the project to at least one of those tasks. Computing device 400 may also request and/or receive status updates from users associated with the project and update the task list accordingly. The updated status may then be displayed, such as in main display area 205, during a subsequent meeting.

An embodiment consistent with the invention may comprise a system for providing meeting state recall. The system may comprise a memory storage and a processing unit coupled to the memory storage. The processing unit may be operative to save a meeting context, associate the meeting context with at least one project, and restore the meeting context at a later meeting associated with the at least one project.

Another embodiment consistent with the invention may comprise a system for providing meeting state recall. The system may comprise a memory storage and a processing unit coupled to the memory storage. The processing unit may be operative to record each of a plurality of events, transcribe the recording for each of the plurality of events, send a copy of the transcription to at least one attendee at each of the plurality of events, capture, during each of the plurality of events, the state of at least one display device associated with each of the plurality of events, maintain an attendance record for a plurality of attendees at each of the plurality of events, and restore the state of the at least one display device to the captured state at the start of a subsequent event of the plurality of events.

Yet another embodiment consistent with the invention may comprise a system for providing meeting state recall. The system may comprise a memory storage and a processing unit coupled to the memory storage. The processing unit may be operative to transcribe a recording of a meeting associated with a project, identify at least one speaker on the recording, capture at least one image of the meeting, save an attendee list of the meeting, save at least one open task item associated with the project, assign the at least one open task item to a user, capture the state of at least one display device operative to display information associated with the project, schedule at least one second meeting at a later time, prepare an agenda for the at least one future meeting, and at the time for the at least one second meeting, repopulate the at least one display device with the captured state.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a whiteboard application 407. Operating system 405, for example, may be suitable for controlling computing device 400's operation. In one embodiment, programming modules 406 may include a presentation application 420. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. presentation application 420) may perform processes including, for example, one or more method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing meeting state recall, the method comprising:
saving a meeting context;
associating the meeting context with at least one project; and
restoring the meeting context at a later meeting associated with the at least one project.

2. The method of claim 1, wherein the meeting context comprises at least one of the following: a current slide of a presentation, an audio recording of the meeting, a transcription of the meeting, an attendee list, a task list, at least one task status, a timeline, a document revision, a projection surface state, and a multi-touch surface state.

3. The method of claim 1, further comprising:
reserving a meeting location at a start time;
associating the reserved meeting location with the at least one project; and
restoring the meeting context in the meeting location at the start time.

4. The method of claim 1, further comprising preparing an agenda for a next meeting according to the saved meeting context.

5. The method of claim 1, further comprising:
recording the meeting;
transcribing the recording; and
displaying the transcribed recording at a next meeting.

6. The method of claim 5, further comprising:
identifying at least one speaker in the recording; and
updating an attendee list for the meeting to indicate the presence of the at least one speaker at the meeting.

7. The method of claim 1, further comprising:
saving a state of an electronic display, wherein the state of the electronic display comprises at least one note associated with the project; and
associating the at least one note with at least one user associated with the project.

8. The method of claim 7, further comprising:
saving the state of the electronic display as a revision of at least one previous state of the electronic display;
displaying a user interface configured to receive a selection of a preview of at least one of the following: the saved state of the electronic display and the at least one previous state of the electronic display;
receiving a selection of the preview; and
restoring a state of the electronic display according to the selected preview.

9. The method of claim 1, further comprising:
scanning at least one document into an electronic form;
associating the at least one electronic document with at least one user associated with the project.

10. A computer-readable medium which stores a set of instructions which when executed performs a method for providing meeting state recall, the method executed by the set of instructions comprising:
recording each of a plurality of events;
transcribing the recording for each of the plurality of events;
sending a copy of the transcription to at least one user associated with the plurality of events;
capturing, during each of the plurality of events, the state of at least one display device associated with each of the plurality of events;
maintaining an attendance record for a plurality of attendees at each of the plurality of events; and
restoring the state of the at least one display device to the captured state at the start of a subsequent event of the plurality of events.

11. The computer-readable medium of claim 10, wherein capturing the state of the at least one display device comprises:
displaying an electronic presentation; and
saving a currently displayed slide of the electronic presentation.

12. The computer-readable medium of claim 10, wherein capturing the state of the at least one display device comprises:
displaying at least one project note on an electronic display; and
saving the at least one project note.

13. The computer-readable medium of claim 12, wherein saving the at least one project note comprises saving a revision of at least one previous project note.

14. The computer-readable medium of claim 10, further comprising:
saving a task list associated with the event; and
associating at least one of the plurality of attendees with at least one unfinished task of the task list.

15. The computer-readable medium of claim 14, further comprising displaying the task list at the start of the subsequent event of the plurality of events.

16. The computer-readable medium of claim 15, further comprising:
receiving a status update from the at least one attendee associated with the at least one unfinished task; and
displaying the updated status of the at least one unfinished task.

17. The computer-readable medium of claim 10, further comprising configuring the state of at least one second display device to the captured state of the at least one display device at the start of the subsequent event of the plurality of events.

18. The computer-readable medium of claim 10, further comprising suggesting at least one agenda item for the subsequent event of the plurality of events.

19. The computer-readable medium of claim 18, wherein the suggested at least one agenda item comprises at least one unfinished task item discussed during at least one previous event.

20. A system for providing meeting state recall, the system comprising:
a memory storage; and
a processing unit coupled to the memory storage, wherein the processing unit is operative to:
transcribe a recording of a meeting associated with a project, wherein the project comprises a plurality of associated users;
identify at least one speaker on the recording as one of the plurality of associated users;
capture at least one image of the meeting;
save an attendee list of the meeting, wherein being operative to save the attendee list comprises being operative to create a record indicating whether or not each of the plurality of associated users was present at the meeting;
save at least one open task item associated with the project;
assign the at least one open task item to at least one of the plurality of associated users;
capture the state of at least one display device operative to display information associated with the project;
schedule at least one second meeting at a later time;
prepare an agenda for the at least one future meeting; and
at the time for the at least one second meeting, repopulate the at least one display device with the captured state.
